(19) United States
(12) Patent Application Publication
(10) Pub. No.: US 2008/0045069 A1
(43) Pub. Date: Feb. 21, 2008

(54) Security system for portable electronic devices

(76) Inventor: Edgar Diego Haren, Houston, TX (US)

Correspondence Address: STOEL RIVES LLP - SLC, 201 SOUTH MAIN STREET, ONE UTAH CENTER, SALT LAKE CITY, UT, 84111, US

(21) Appl. No.: 11/501,484

(22) Filed: Aug. 8, 2006

(51) Int. Cl. H01R 13/627; G08B 13/14

(52) U.S. Cl. 439/352; 340/568.2

(57) ABSTRACT

Provided herein is a security system for a portable electronic device comprising a port connector, a latching mechanism, and a locking mechanism. Also provided is a method for securing a portable electronic device and a security system configured as a multiple-piece shell.

### FIELD OF THE INVENTION

The present invention relates generally to a security system for portable electronic devices and a method for securing such portable devices.

### BACKGROUND OF THE INVENTION

Portable electronic devices are playing an increasingly important role in the lives of individuals. Cellular phones, personal digital assistants, mobile media players, laptop computers, and digital cameras, among many other portable electronic devices, are valued tools for work and recreation. The role played by such portable devices in business, entertainment, and communications will undoubtedly increase over time.

A desirable characteristic of many of these devices—their relative portability—makes these devices particularly vulnerable to theft. Therefore, as the popularity of these devices grows, so too does the need for security systems that can effectively and conveniently protect these devices from theft.

Although security devices for these portable devices exist in the market, few provide security from both theft and unauthorized access. Most security systems can secure the device from physical theft, but they generally provide no security for the functional aspects of the device. For example, an ordinary lock for a digital music player might prevent the device from being carried away, but does not prevent a thief from accessing the player's data through the device's data port. A security system that can prevent the portable device from being carried away and which also protects the device's communication or data port would offer a substantial advantage over ordinary locks by diminishing the functionality of the device. Such a dual purpose security device could even deter theft, since forced removal of the security device could permanently impair the functionality of the device.

### BRIEF SUMMARY OF THE INVENTION

The present invention is directed towards a security system for a portable electronic device. In some embodiments, the security system comprises: a port connector configured to mate with a complimentary connector of the portable electronic device; a latching mechanism configured to secure the port connector to the complementary connector; and a locking mechanism configured to control the release and engagement of the latching mechanism. The portable electronic device may comprise at least one of a personal digital assistant, a portable electronic media player, a portable telephone, a portable electronic game device, a laptop computer, a portable navigation device, a portable television, and a digital camera. The complementary connector of the portable electronic device may comprise at least one of a data port, a battery charging port, and an audio-visual port. The port connector may be configured to aesthetically match the appearance of the portable electronic device.

In some embodiments, a cable is attached to the port connector and the cable is configured to secure the security system and the portable electronic device to an object. The cable may be configured as an eyelet loop. The eyelet loop may be attached to the port connector through a length of additional cable. In some embodiments, the cable is a retractable cable that retracts into the port connector or a portable base unit. The portable base unit may be attached to an additional cable that is configured to secure the portable base unit to an object.

The invention may further comprise a conductive cable. The conductive cable may be attached to a pass-through connector configured to mate with a complementary connector of an electronic device or power source.

In some embodiments, the latching mechanism comprises at least one of a locking pin, a locking tooth, and a locking bar.

In some embodiments, the locking mechanism comprises at least one of a key lock and a keyless lock. The keyless lock may comprise at least one of a combination lock and an electronic lock.

The invention also encompasses a method for securing a portable electronic device. This method comprises: mating a port connector with a complementary connector of the portable electronic device; securing the port connector to the complementary connector using a latching mechanism; and controlling the release and engagement of the latching mechanism with a locking mechanism.

In other embodiments, the invention may comprise a multiple-piece shell configured to open and close. The shell is further configured to fit around a connector, which is configured to mate with a complementary connector of the portable electronic device. The shell is further configured to block access to the mechanism controlling the release or engagement of the connector to the complementary connector of the portable electronic device. The shell also includes a locking mechanism configured to control the opening and closing of the multiple-piece shell.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating one example implementation of the security system in accordance with one embodiment of the invention.

FIG. 2 is a diagram illustrating one embodiment of the security system engaged and locked in place with an exemplary portable electronic device.

FIG. 3 is a diagram illustrating various configurations of a cable attached to a port connector.

FIG. 4 is a diagram illustrating embodiments of the security system configured to include one or more conductive cables attached to pass-through connectors.

FIG. 5 is a diagram illustrating exemplary configurations of the latching mechanism.

FIG. 6 is a diagram illustrating exemplary configurations of the locking mechanism.

FIG. 7 is a diagram illustrating one example implementation of security system configured as a multiple-piece shell.

### DESCRIPTION OF THE PREFERRED EMBODIMENTS

The present invention is directed toward various approaches to securing a portable electronic device. As used herein, the term portable electronic device is a broad term that can refer to any of numerous electronic devices, including cellular phones, personal digital assistants, mobile media players, laptop computers, LCD monitors, and digital cameras. The term portable need not mean light in weight or small. Heavy and large electronic devices, such as television sets, for example, may also be portable. After reading this description, it will become apparent to one of ordinary skill in the art that the invention's utility will not be restricted only to those portable electronic devices in use today, but also any that might be developed in the future.

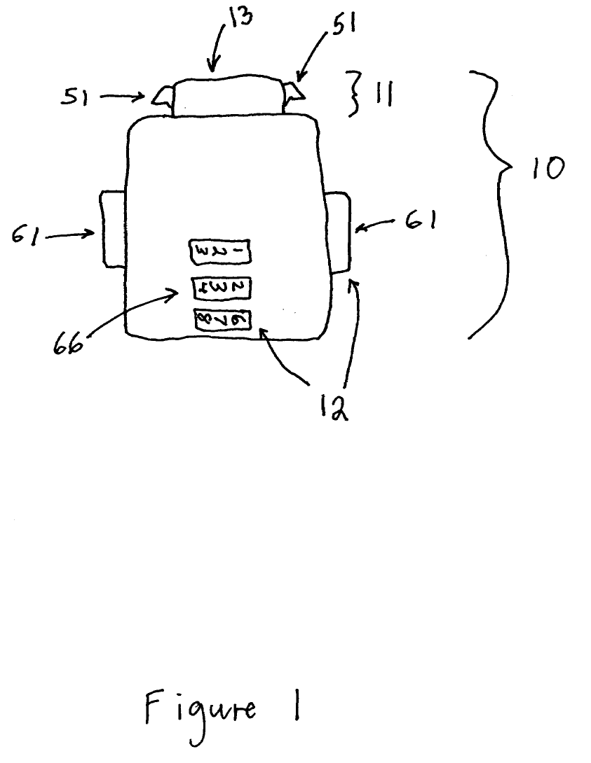

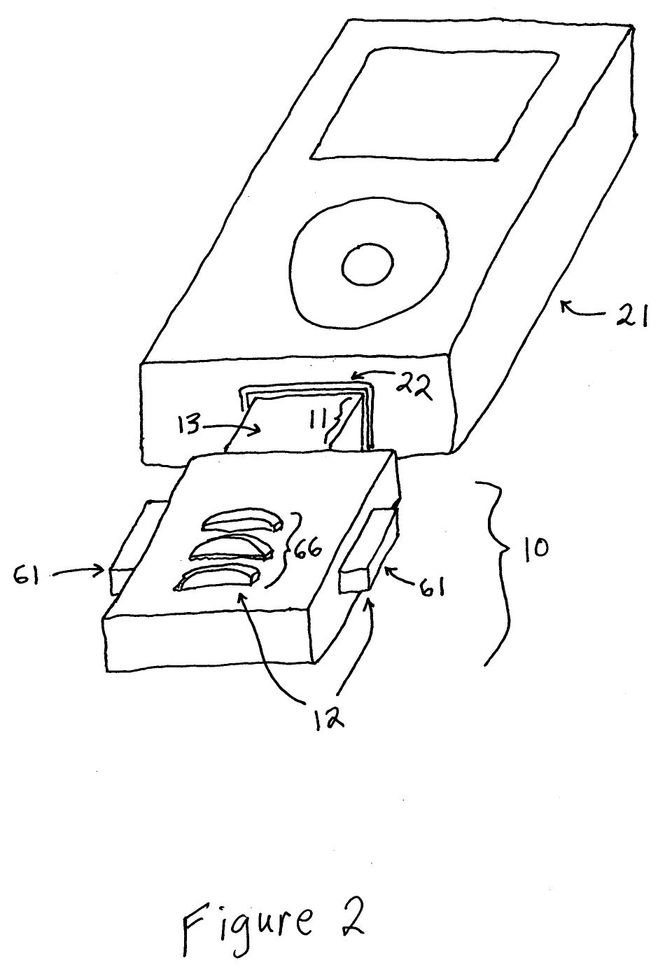

FIG. 1 is a diagram illustrating one example implementation of the invention. The embodiment illustrated in FIG. 1 may be used to diminish the functionality of a portable electronic device 21 by preventing access to a complementary connector 22 on the device (see FIG. 2). Such decreased functionality could serve to deter theft of the device. As illustrated in FIG. 1, some embodiments of the invention comprise a port connector 10 that is configured to mate with a complementary connector of a portable electronic device 21. For example, in some embodiments, the port connector 10 may be configured to mate with existing or after-developed ports on a laptop computer or a data port on a portable mp3 player or another electronic device. The complementary connector 22 may be any of numerous types found on various portable electronic devices, such as video ports, power ports, printer ports, audio ports, data ports, and card slots, to name a few.

In some embodiments, the port connector 10 may be configured to mate with more than one type of connector 22 on a portable electronic device 2 1. In other embodiments, the port connector 10 may be configured to mate with complementary connectors 22 of multiple portable electronic devices 21 simultaneously. In some embodiments, the port connector 10 may be configured and designed to match the aesthetic characteristics of a portable electronic device 21. For example, a port connector may be configured and designed to aesthetically match a specific brand of laptop computer or portable mp3 player in color, shape, and texture and the like.

Some embodiments of the invention comprise a latching mechanism 11 (FIG. 1) configured to secure the port connector to a complementary connector 22 on a portable electronic device 21 or to otherwise secure the mechanism to the electronic device. The latching mechanism 11 may include multiple components, such as a component 13 that permits the security device to fit into a connector 22 on a portable electronic device 21 as well as a component to keep it in place (e.g., 51 and 52). As illustrated in FIG. 2, the latching mechanism 11 may serve to lock the invention directly on to a complementary connector 22 on a portable electronic device 21. In one embodiment, for example, the latching mechanism 11 is configured to mate with and latch to the complementary connector 22 on the device. In other embodiments, the latching mechanism 11 can include locking bars 52, pins, tabs or other device or member that fits into an opening on the casing of the electronic device and pivots, translates or expands to engage the back periphery of the opening, thereby preventing removal of the port connector 10 from the electronic device 21.

As used herein, the terms “secure” and “prevent removal” and their variants are used broadly. For example, in some embodiments, the latching mechanism 11 may serve to lock the port connector 10 firmly in place. In other embodiments, the latching mechanism 11 may serve only to hold the port connector 10 in position, allowing easier removal. In some embodiments, for example, the latching mechanism 11 may, when engaged, prevent unauthorized removal of the connector from the device without causing damage to the device.

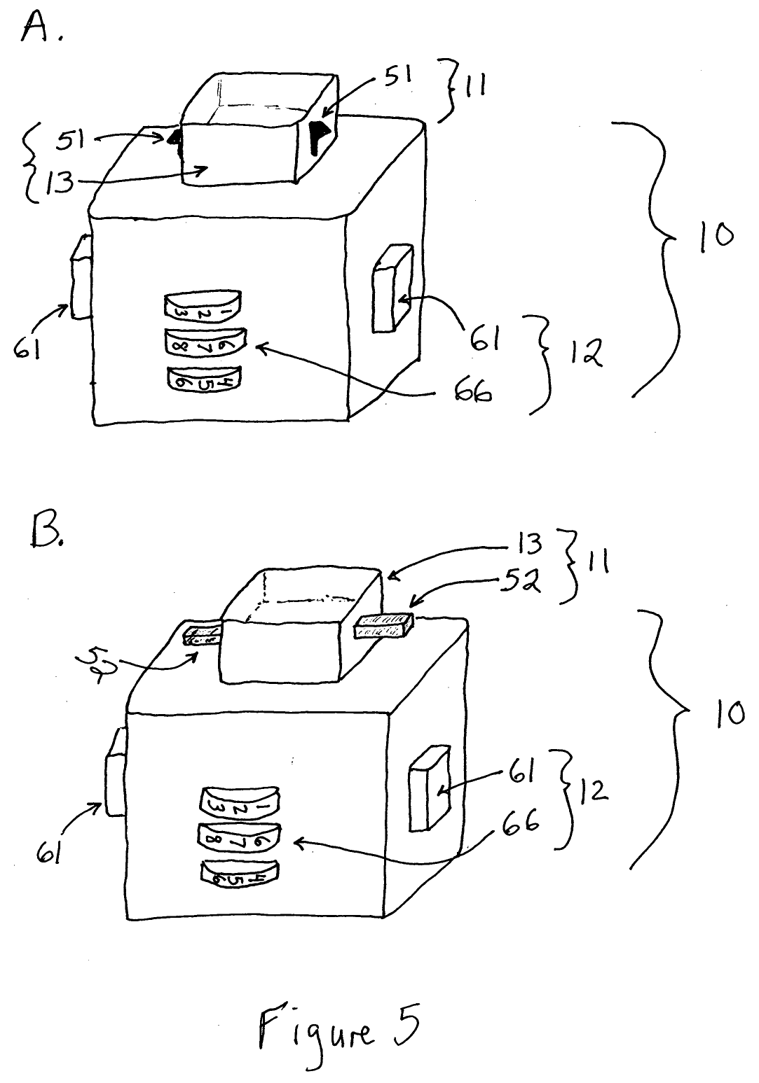

Some illustrative configurations for the latching mechanism can be seen in FIG. 5. In some embodiments, the latching mechanism 11 may comprise angular teeth 51. In other embodiments, the latching mechanism 11 may comprise relatively straight locking bars 52. The component 13 that fits into a connector of a portable electronic device can, of course, assume a shape complementary to any particular connector on a portable electronic device. It will be apparent to one of ordinary skill in the art that the latching mechanism 11 can assume any of numerous other configurations that function to hold the port connector 10 securely in place. In some embodiments, the latching mechanism 11 may resemble that of the usual connector for the portable electronic device 21. In other embodiments, the latching mechanism 11 may be different from that of the usual connector in order to provide more security for the portable electronic device 21. For instance, the latching mechanism 11 may have longer locking bars 52 than the usual connector in order to more firmly secure the port connector to the portable electronic device 21. As one example, the latching mechanism 11 of the invention could be configured to have longer and stronger locking bars 52 or pins than the usual recharging connector for a portable mp3 player.

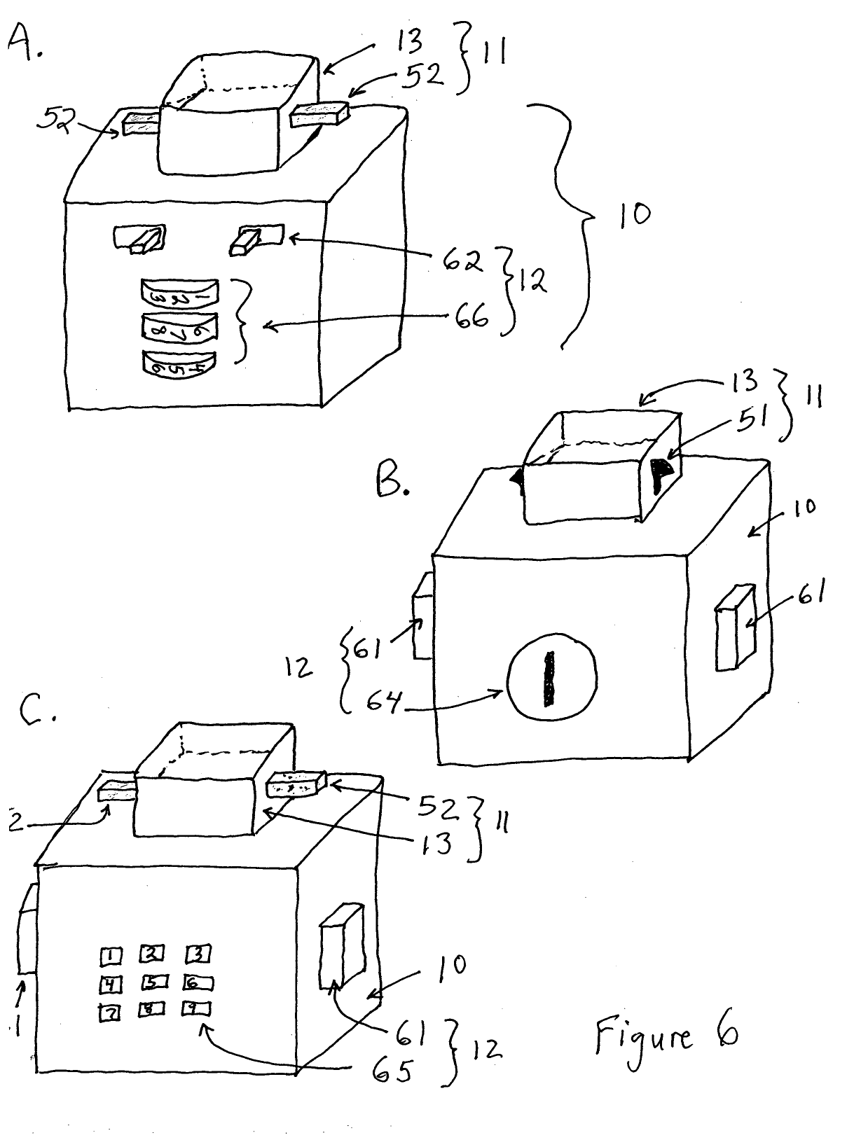

Some embodiments of the invention comprise a locking mechanism 12 (FIG. 1) configured to control the release and engagement of the latching mechanism 11. The locking mechanism 12 may generally permit the user to attach or detach the security system from portable electronic device 21. In some embodiments, the locking mechanism 12 may include actuators in the form of buttons 61 (FIG. 6) on the body of the port connector 10 that control the release and engagement of the latching mechanism 11. In other embodiments, the locking mechanism 12 may comprise actuators in the form of sliding levers 62 (e.g., FIG. 6A) that control the release and engagement of the latching mechanism 11. In some embodiments, the locking mechanism 12 may comprise electronic controls (e.g., 65 in FIG. 6C). It will be apparent to one of ordinary skill in the art that the locking mechanism 12 can assume any of numerous configurations.

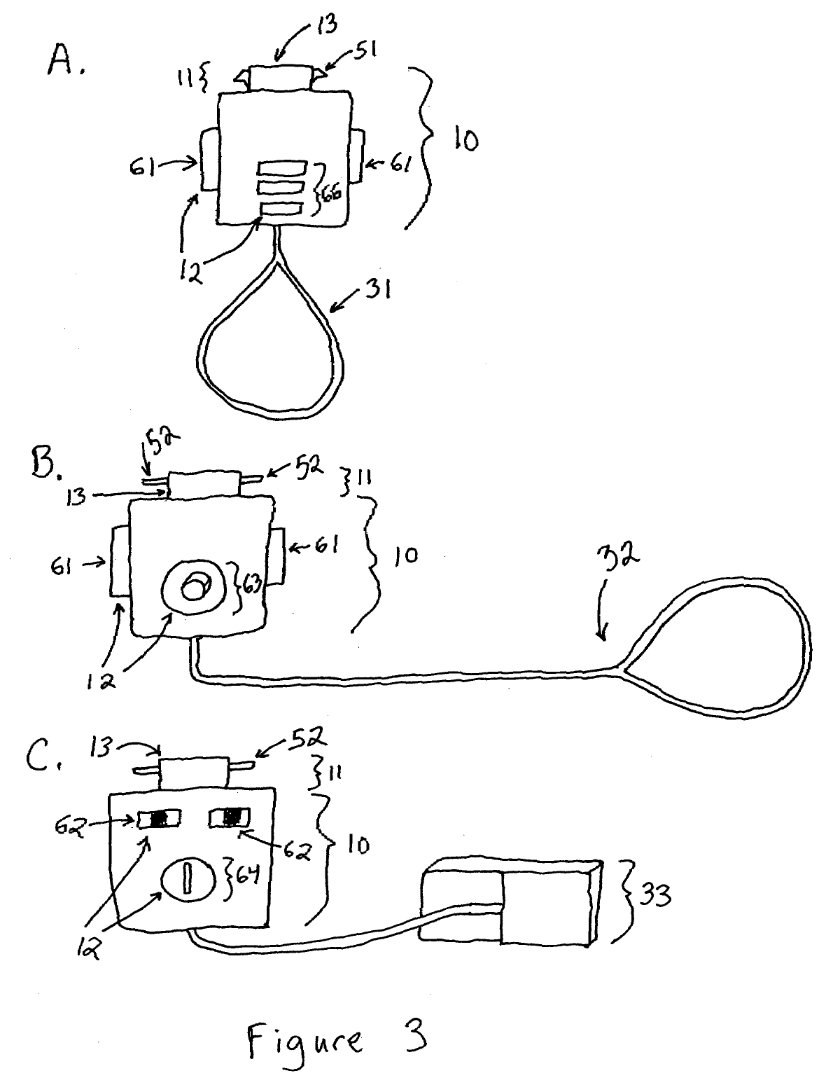

In some embodiments, the locking mechanism 12 may include a lock (e.g., 63, 64, and 65) that prevents unauthorized removal of the port connector 10 from the complementary connector 22 of a portable electronic device 21. For example, a lock can be used to lock or prevent unauthorized operation of the locking mechanism, inhibiting actuation of the latching mechanism 11 and thereby preventing release of the latching mechanism 11. In some embodiments, the lock may be configured as a combination lock 63 (FIG. 3B). For example, the combination lock 63 may be a three-wheeled tumbler 66 (FIG. 6A) with numbers that must be set to the correct position in order for the port connector to be removed. In other embodiments, the lock may be configured as a key lock 64 (FIG. 6B), into which a matching key must be inserted in order to disengage the locking mechanism 12. In some embodiments, the lock may be configured as a keyless digital lock 65 (FIG. 6C) requiring the entry of an alphanumeric combination to disengage the locking mechanism 12. In another embodiment, not illustrated, a biometric sensor such as, for example, a fingerprint scanner, can be used to actuate the locking mechanism. It will be apparent to one of ordinary skill in the art that virtually any type of lock may be used as part of this invention. In some embodiments, the user of the invention will be able to alter the characteristics of the lock—e.g., altering the combination required to disengage the locking mechanism. In other embodiments, the lock may be configured to prevent even the user from disengaging the locking mechanism 12, in which case the invention would function to permanently disable the connector 22 of a portable electronic device 21. Permanent disablement of a connector 22 may be desirable, for example, if the user wishes to permanently discard the portable electronic device 21 while decreasing any risk of having data or other information stolen from the device after it has been discarded.

In some embodiments, the invention will include a cable (e.g., 31, 32, and 33) attached to the port connector 10 (FIG. 3). The cable could perform a variety of functions. For example, the cable could facilitate hand-carrying of the portable electronic device or serve to secure the device to another object, such as a backpack or desk. The cable could be configured in any of numerous shapes and forms. For example, the cable could be in the form of an eyelet loop 31 (FIG. 3A) that can be used to hand-carry the portable electronic device or secure the device to a cable lock. Alternatively, the cable could be configured as an eyelet loop at the end of an extended length of cable 32 (FIG. 3B), which would allow the portable electronic device 21 to be secured around an object such as a desk leg (e.g., by encircling the object with the cable, passing the port connector through the eyelet loop, and then attaching the port connector 10 to the portable electronic device 21). In other embodiments, the cable attached to the port connector 10 may be configured to retract into a separate portable base unit 33 or the port connector 10 itself to permit easier storage of the cable. The cable could be made of steel or a similar material and can be coated, for example, with a polyvinyl or other rubber-like coating. One of ordinary skill in the art would know that the cable could be made from a variety of materials and can include a variety of coatings.

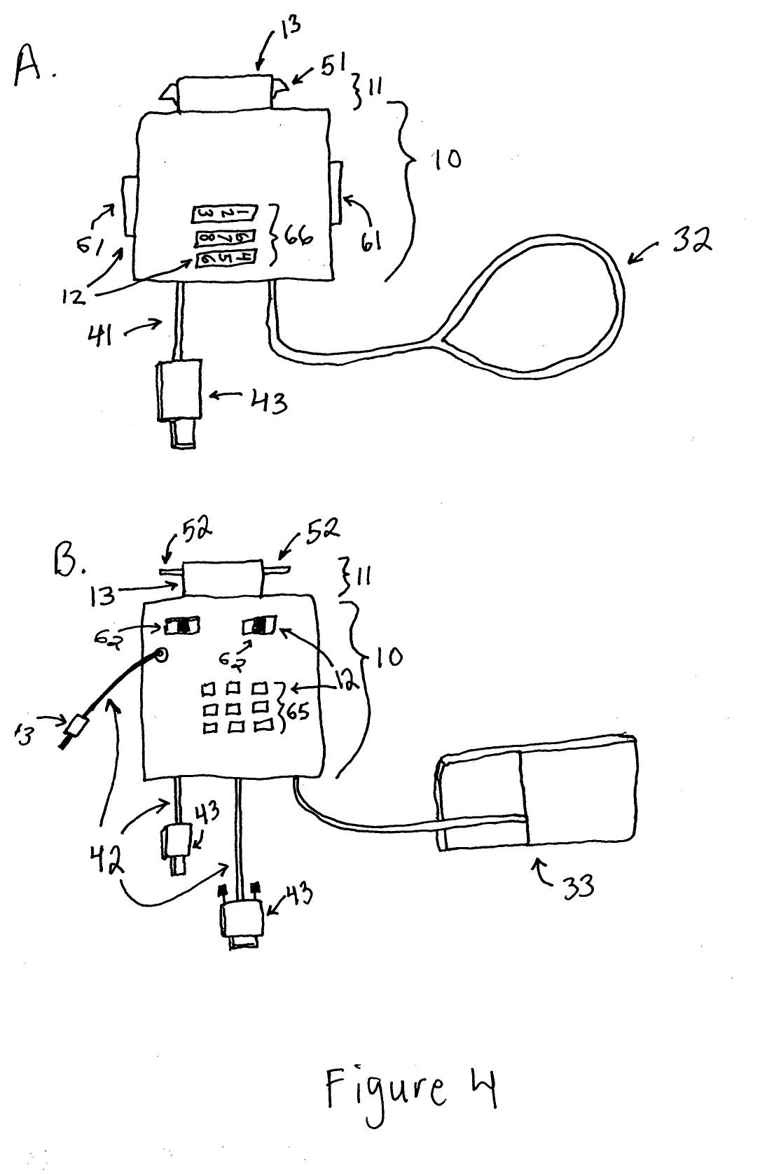

In some embodiments, a conductive cable 41 (FIG. 4A) may be attached to the port connector 10. The conductive cable 41 and the attached pass-through connector 43 may allow the user to secure the portable electronic device 21 while maintaining the full functionality of the device. The conductive cable 41 and attached pass-through connector may be configured to conduct electrical power, electrical signals, optical signals or any other type of transmission or signals to and/or from the portable electronic device. There may be a single conductive cable 41 or multiple conductive cables 42 with multiple attached pass-though connectors 43, which may be of different or similar types (FIG. 4B). The conductive cable may be in addition to or in place of the security cable (e.g., 31, 32, or 33) described above. In some embodiments, the conductive cable 41 is attached to a pass-through connector 43 configured to mate with a complementary connector of an electronic device or power source. The pass-through connector 43 may be, for example, a standard connector configured to mate with the complementary connector on the electronic device. The pass-through connector 43 may also be configured as a power plug. It is not necessary for the pass-through connector 43 to have the same configuration as the latching mechanism 11 of the port connector 10 to which the conductive cable 41 is attached (see, e.g., FIG. 4B). For instance, in some embodiments, the port connector 10 could be configured to transform or convert signals or currents. As an example, the latching mechanism 11 of the port connector 10 may be configured to mate with a power port on a portable electronic device 21 while the pass-through connector 43 attached to the port connector's conductive cable 41 is configured to mate with a U.S. three-prong or European two-prong power outlet. In some embodiments, the port connector 10, latching mechanism 11, or pass-through connectors 43 may be comprised of modular units configured to be easily changed or switched. For example, the pass-through connector may be comprised of a modular unit (not illustrated) that can be switched between U.S. and European power outlet configurations. Additional versatility may be incorporated into the invention if, for example, the locking mechanism 12 were configured to also control the functionality of the conductive cable 41. For instance, a locking mechanism 12 may permit a user to deactivate one or all conductive cables 42 attached to a port connector 10, therefore permitting only the user to enjoy the full functionality of the portable electronic device.

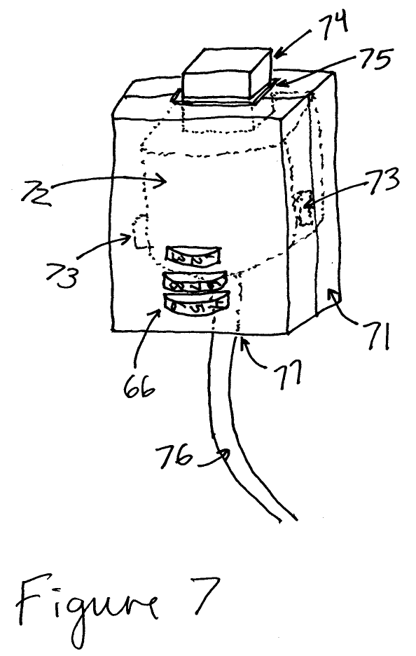

In some embodiments, the security system may be comprised of a shell 71 configured to fit over the usual connector 72 and block access to the portions of the connector that function to control the engagement or disengagement of the connector 73 (FIG. 7). The shell security system may include elements seen in other embodiments of the invention—e.g., a combination lock 66 or a steel cable configured as an eyelet loop. For example, in this embodiment, the shell can comprise two (or more) body members that are configured to be locked together to form an enclosed partially enclosed shell 71. The members can be locked around the existing device port connector 72, such that they allow the mating portion of the connector 74 to extend through or be accessible through a first opening 75 in the shell. The cable portion of the existing connector 76 can pass through a second opening 77 in the enclosed shell. With the shell locked around the existing connector 72 access is blocked to the actuating mechanism 73 that controls the latches or other members that secure the connector 72 to the device. As such, in one embodiment, with the shell 71 properly engaged the connector 72 cannot be removed from the device without damaging the connector or the device.

In reading this description, one of ordinary skill in the art would know that the security system described herein could include other features that can enhance the utility or convenience of the system. For example, the port connector could include an audible or visual alarm that would be activated by the jerking caused by a forcible attempt at removing the port connector from the connector on a portable electronic device. As another example, instead of a cable attached to the port connector, the port connector may include an attached belt clip. In another embodiment, a portable base unit may include a second retractable cable that can be used to secure the portable base unit, port connector, and portable electronic device to an object such as a desk or backpack.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known,” “usual,” and terms of similar meaning should not be construed as limiting the item described to a given time period or to an item available as of a given time, but instead should be read to encompass conventional, traditional, normal, usual, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

What is claimed is:

1. A security system for a portable electronic device, comprising:
a port connector configured to mate with a complementary connector of the portable electronic device;
a latching mechanism configured to secure the port connector to the complementary connector; and
a locking mechanism configured to control the release and engagement of the latching mechanism.

2. The security system of claim 1, wherein the portable electronic device comprises at least one of a personal digital assistant, a portable electronic media player, a portable telephone, a portable electronic game device, a laptop computer, a portable navigation device, a portable television, and a digital camera.

3. The security system of claim 1, wherein the complementary connector of the portable electronic device comprises at least one of a data port, a battery charging port, and an audio-visual port.

4. The security system of claim 1, wherein the port connector aesthetically matches the appearance of the portable electronic device.

5. The security system of claim 1, wherein a cable is attached to the port connector and the cable is configured to secure the security system and the portable electronic device to an object.

6. The security system of claim 5, wherein the cable is configured as an eyelet loop.

7. The security system of claim 6, wherein the eyelet loop is attached to the port connector through a length of additional cable.

8. The security system of claim 5, wherein the cable is a retractable cable that retracts into the port connector or a portable base unit.

9. The security system of claim 8, wherein the portable base unit is attached to an additional cable that is configured to secure the portable base unit to an object.

10. The security system of claim 5, further comprising a conductive cable.

11. The security system of claim 10, wherein the conductive cable is attached to a pass-through connector configured to mate with a complementary connector of an electronic device or power source.

12. The security system of claim 1, wherein a conductive cable is attached to the port connector, and the conductive cable is attached to a pass-through connector configured to mate with a complementary connector of an electronic device or power source.

13. The security system of claim 1, wherein the latching mechanism comprises at least one of a locking pin, a locking tooth, and a locking bar.

14. The security system of claim 1, wherein the locking mechanism comprises at least one of a key lock and a keyless lock.

15. The security system of claim 14, wherein the keyless lock comprises at least one of a combination lock and an electronic lock.

16. A method for securing a portable electronic device, comprising: mating a port connector with a complementary connector of the portable electronic device; securing the port connector to the complementary connector using a latching mechanism; and controlling the actuation of the latching mechanism with a locking mechanism.

17. A security system for a portable electronic device, comprising:
a multiple-piece shell configured to open and close and further configured to fit around a connector configured to mate with a complementary connector of the portable electronic device, wherein the shell is further configured to block access to the mechanism controlling the release or engagement of the connector to the complementary connector of the portable electronic device; and
a locking mechanism configured to control the opening and closing of the multiple-piece shell.
